(19) United States
(12) Patent Application Publication
(10) Pub. No.: US 2023/0311151 A1
(43) Pub. Date: Oct. 5, 2023

(54) GARDENING SPRINKLER

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD., Changhua (TW)

(21) Appl. No.: 17/713,092

(22) Filed: Apr. 4, 2022

(51) Int. Cl. B05B 15/625

(52) U.S. Cl. CPC B05B 15/625

(57) ABSTRACT

A gardening sprinkler may include a sprinkler base, and two first main bodies are respectively formed at two lateral sides of the sprinkler base while two second main bodies are respectively formed at the front side and the rear side of the sprinkler base, so as to form the sprinkler base in a firm-structure frame shape. The first main bodies and the second main bodies are formed in hollow with thin shell, and a plurality of hollow holes are formed thereon to reduce the weight of the sprinkler base and lower the cost of production, thereby achieving the effects of environmental protection and energy saving. The hollow holes are adapted to reserve space to allow a turf to well grow therefrom.

### FIELD OF THE INVENTION

The present invention relates to a gardening sprinkler and more particularly to a gardening sprinkler with thin hollow shell structure and hollow holes.

### BACKGROUND OF THE INVENTION

Referring to FIG. 12, the conventional gardening sprinkler (40) comprises a base (40) having a water inlet hole (411) and a water outlet hole (not shown in FIG.) thereon, and the water inlet hole (411) is connected to the water source while the base (40) comprises a plurality of sprinkler pipes (42) which are connected to the water outlet hole. When water flows from the water inlet hole (411) into the gardening sprinkler (40), the rotary pendulum movement between the base (41) and the sprinkler pipes (42) is adapted to drive the sprinkler pipes (42) to complete reciprocating circumferential spraying. Moreover, each of two lateral sides of the base (40) has a plurality of supporting legs (412), and each of the supporting legs (412) comprises at least a ground stake (43) to insert the lawn, so as to secure the gardening sprinkler (40) on the ground.

However, the conventional gardening sprinkler has following disadvantages: (i) the base (41) formed integrally is solid, which increases the cost of manufacturing and endangers the environment; (ii) the base (41) covers whole turf, which affects the growth of the turf and damages the ecosystem; (iii) the base (41) must be used with the ground stake (43) to be firmly positioned on the turf, that makes the operation time-consuming and costly; and (iv) the look of the base (41) is monotonous and not three-dimensional, which lowers the practicability thereof. Therefore, there remains a need for a new and improved design for a gardening sprinkler to overcome the problems presented above.

### SUMMARY OF THE INVENTION

The present invention provides a gardening sprinkler comprising a sprinkler base, and two first main bodies are respectively formed at two lateral sides of the sprinkler base while two second main bodies are respectively formed at the front side and the rear side of the sprinkler base, so as to form the sprinkler base in a firm-structure frame shape. The first main bodies and the second main bodies are formed in hollow with thin shell, and a plurality of hollow holes are formed thereon, so as to reduce the weight of the sprinkler base and lower the cost of production, thereby achieving the effects of environmental protection and energy saving. The hollow holes are adapted to reserve space so as to allow a turf to well grow therefrom.

Comparing with conventional gardening sprinkler, the present invention is advantageous because: (i) the first main bodies and the second main bodies are made in thin hollow shell structure with the hollow holes thereon, which achieves the purposes of lightweight design and environmental protection; (ii) the hollow holes avoid the turf being covered by the sprinkler base, which enables the turf to grow smoothly so as to create the pleasant ecological environment for living creatures; (iii) the turf grows from the hollow holes that also allows the sprinkler base to be secured on the ground firmly without the ground stakes, which keeps the turf from damage and provides the user with convenience in operation; and (iv) sprinkler base is formed into three-dimensional hollow shape, which increases the practicability and ornamental values.

### BRIEF DESCRIPTION OF THE DRAWINGS

FIG. 1 is a three-dimensional assembly view of a gardening sprinkler of the present invention.

FIG. 2 is a sectional assembly view of the gardening sprinkler of the present invention.

FIG. 3 is a sectional view from another angle of the gardening sprinkler of the present invention.

FIG. 4 is a schematic view illustrating a sprinkler pipe is installed on a sprinkler base of the gardening sprinkler in the present invention.

FIG. 5 is a schematic view illustrating the gardening sprinkler of the present invention is in use.

FIG. 6 is a three-dimensional assembly view of a second embodiment of the gardening sprinkler of the present invention.

FIG. 7 is a sectional assembly view of the second embodiment of the gardening sprinkler of the present invention.

FIG. 8 is a schematic view illustrating the second embodiment of the gardening sprinkler of the present invention is in use.

FIG. 9 is a three-dimensional assembly view of a third embodiment of the gardening sprinkler of the present invention.

FIG. 10 is a sectional assembly view of the third embodiment of the gardening sprinkler of the present invention.

FIG. 11 is a schematic view illustrating the third embodiment of the gardening sprinkler of the present invention is in use.

FIG. 12 is a prior art.

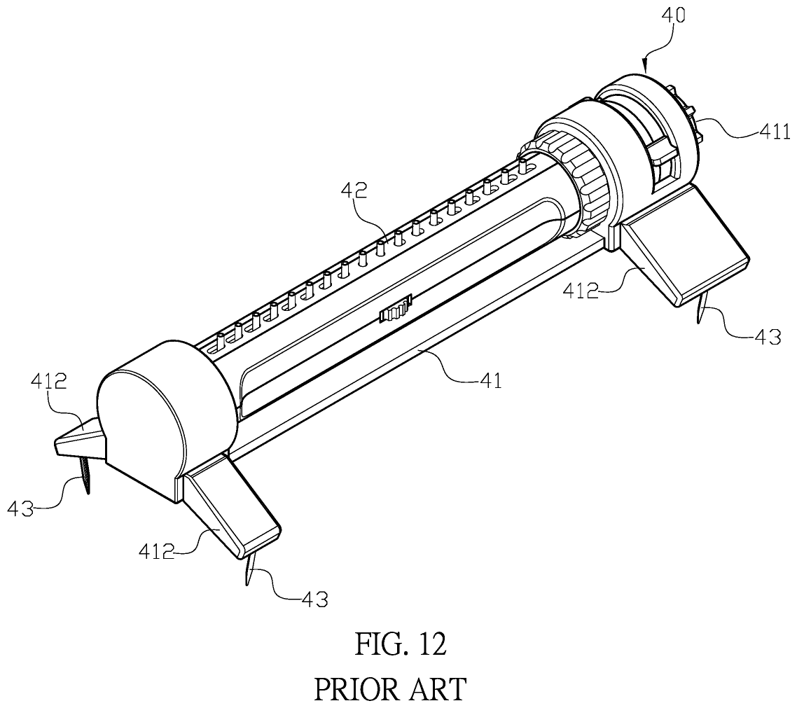

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

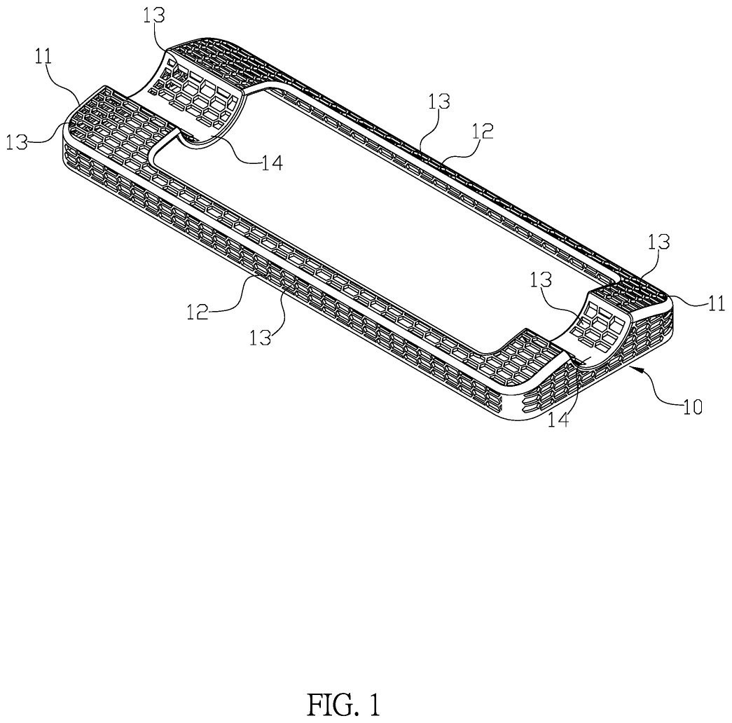

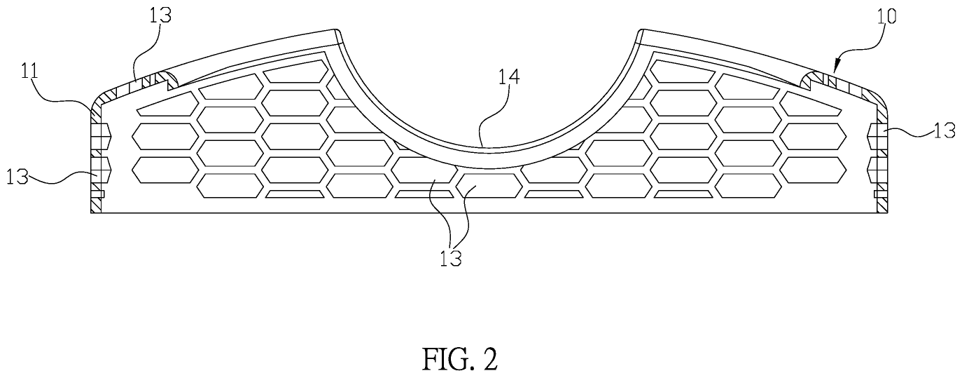

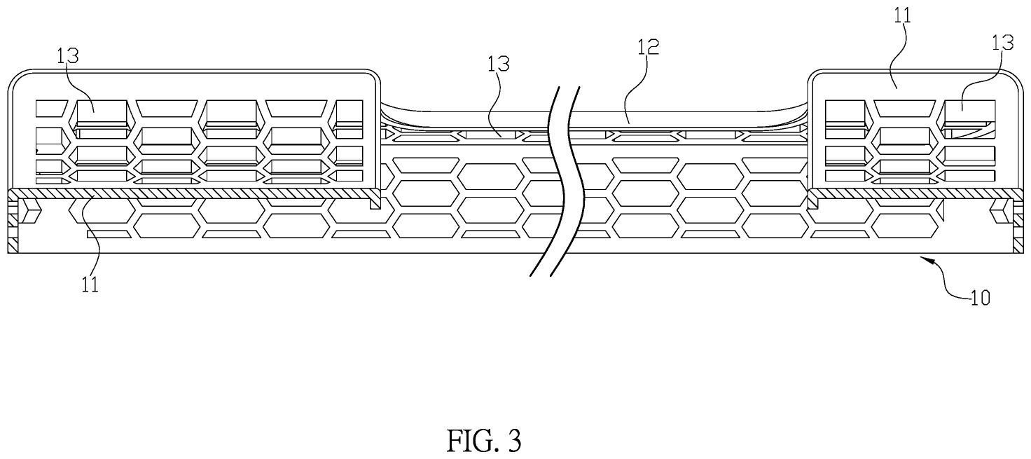

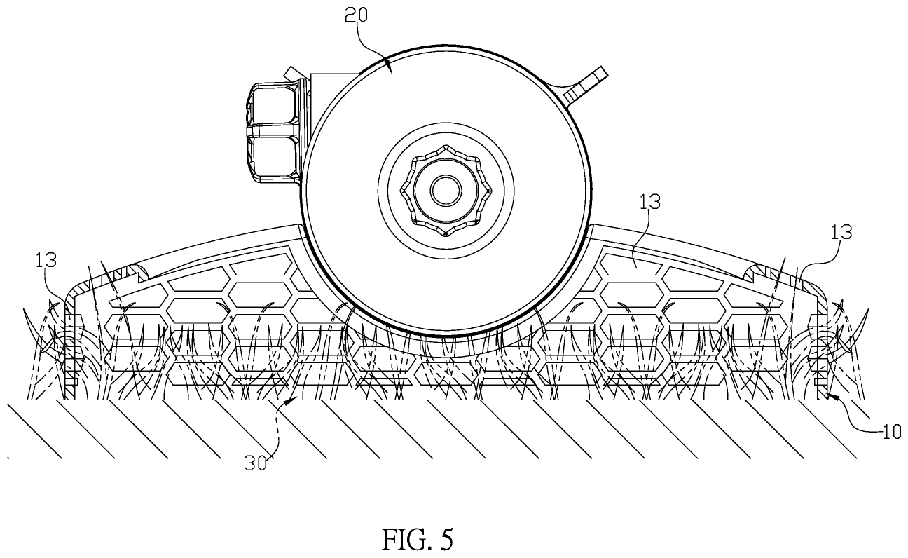

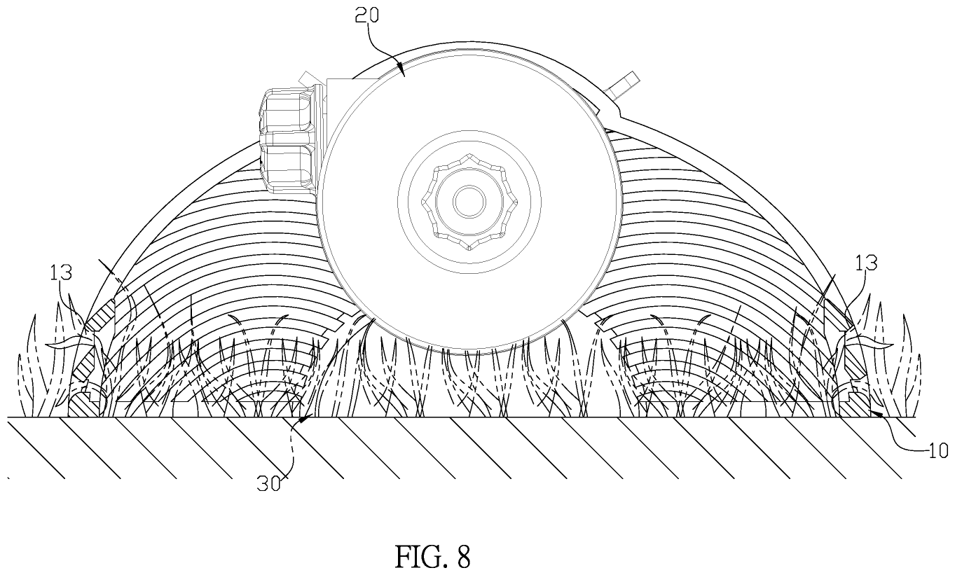

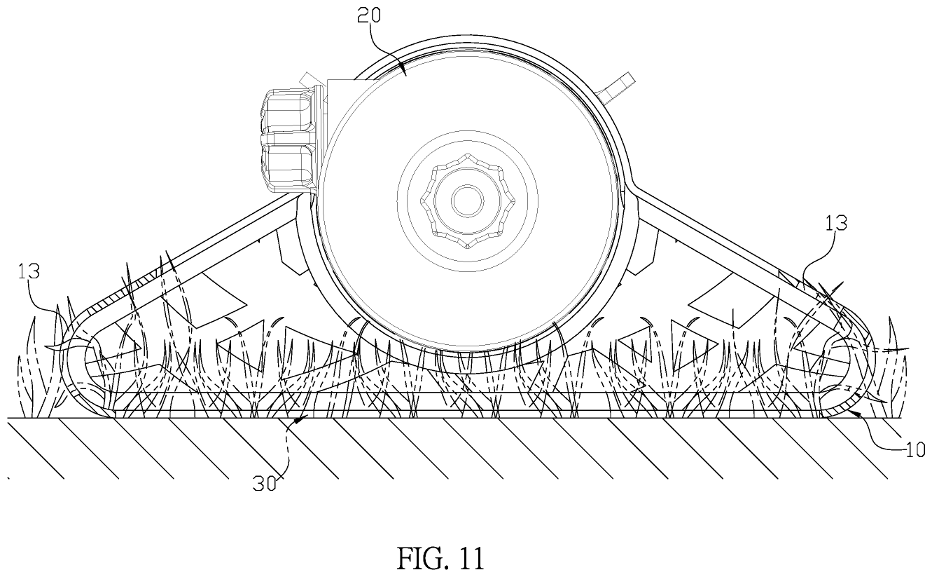

Referring to FIGS. 1 to 3, the present invention provides a gardening sprinkler comprising a sprinkler base (10), and two first main bodies (11) are respectively formed at two lateral sides of the sprinkler base (10) while two second main bodies (12) are respectively formed at the front side and the rear side of the sprinkler base (10), so as to form the sprinkler base (10) in a firm-structure frame shape. Moreover, the first main bodies (11) and the second main bodies (12) are formed in hollow with thin shell, and a plurality of hollow holes (13) are formed thereon, which not only effectively reduces the weight of the sprinkler base (10) but also remarkably lowers the cost of production, thereby achieving the effects of environmental protection and energy saving. Furthermore, the hollow holes (13) are adapted to reserve space so as to allow a turf (30) to well grow therefrom (as shown in FIGS. 5, 8 and 11).

In one embodiment, the sprinkler base (10) is integrally made of metal.

In another embodiment, the sprinkler base (10) is manufactured through injection molding production by more than two sets of molds.

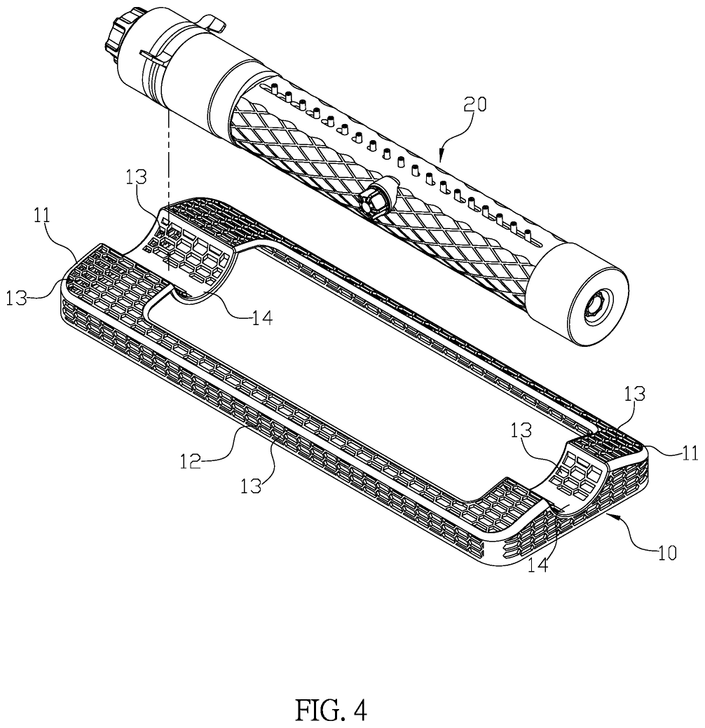

In still another embodiment, each of the first main bodies (11) has a connecting portion (14) at corresponding positions, and the connecting portion (14) is adapted to connect to a sprinkler pipe (20) to achieve watering (as shown in FIGS. 4, 5, 8 and 11).

In a further embodiment, each of the first main bodies (11) has the connecting portion (14) at corresponding positions, and the connecting portion (14) is adapted to connect to the sprinkler pipe (20) to achieve watering (as shown in FIGS. 4, 5, 8 and 11), and the plurality of hollow holes (13) are formed on the connecting portions (14).

In still a further embodiment, the hollow holes (13) are formed in honeycomb shape (as shown in FIGS. 1 to 5).

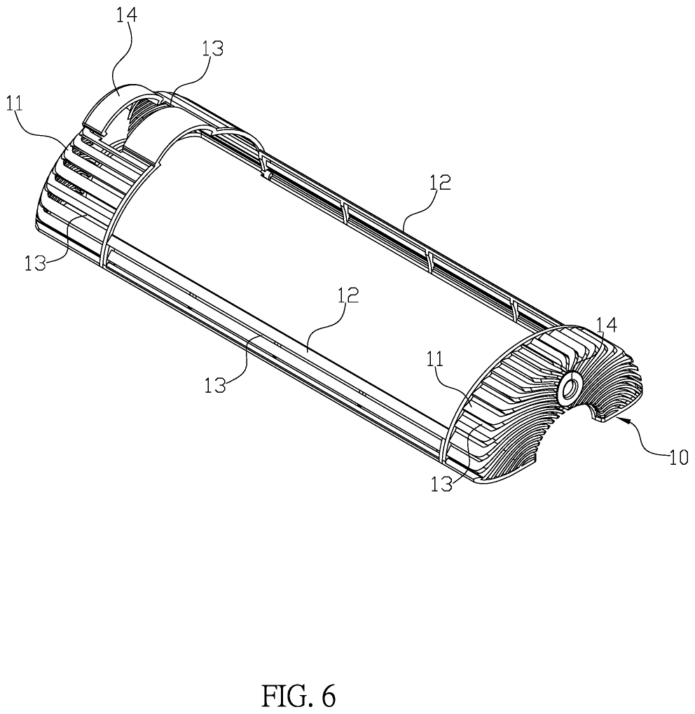

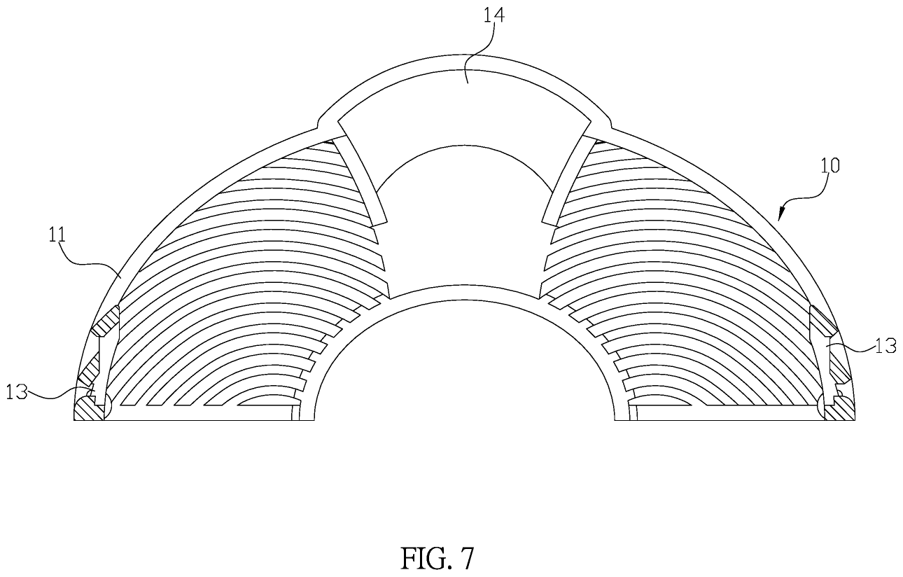

In a preferred embodiment, the hollow holes (13) are formed in swirling shape (as shown in FIGS. 6 to 8).

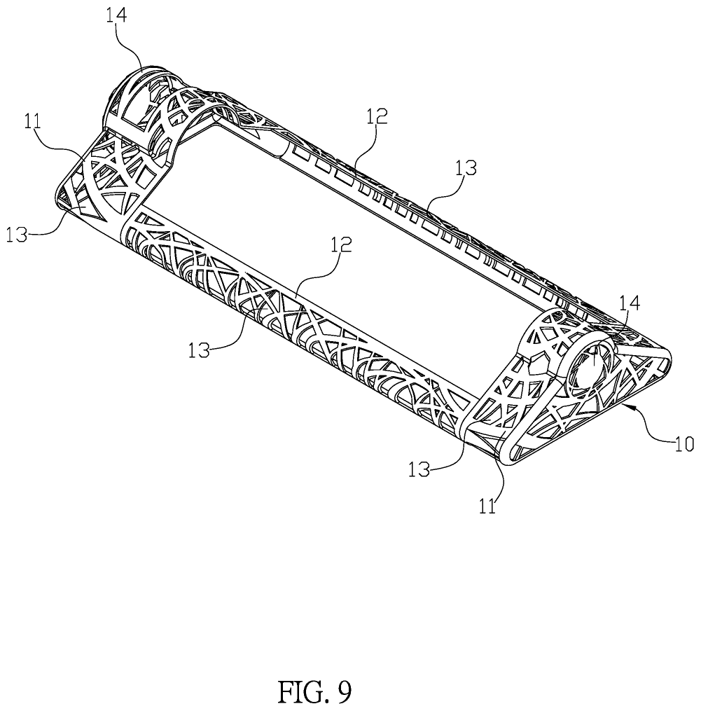

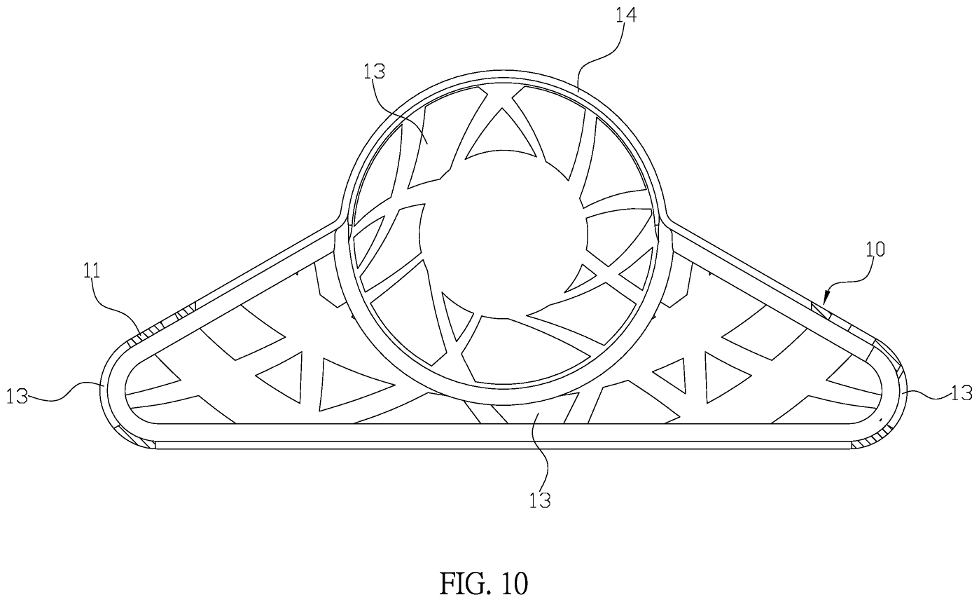

In another preferred embodiment, the hollow holes (13) are formed in irregular nest shape (as shown in FIGS. 9 to 11).

Comparing with conventional gardening sprinkler, the present invention is advantageous because: (i) the first main bodies (11) and the second main bodies (12) are made in thin hollow shell structure with the hollow holes (13) thereon, which achieves the purposes of lightweight design and environmental protection; (ii) the hollow holes (13) avoid the turf (30) being covered by the sprinkler base (10), which enables the turf (30) to grow smoothly so as to create the pleasant ecological environment for living creatures (as shown in FIGS. 5, 8, and 11); (iii) the turf (30) grows from the hollow holes (13) that also allows the sprinkler base (10) to be secured on the ground firmly without the ground stakes, which keeps the turf (30) from damage and provides the user with convenience in operation; and (iv) sprinkler base (10) is formed into three-dimensional hollow shape, which increases the practicability and ornamental values.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A gardening sprinkler comprising a sprinkler base;
wherein two first main bodies are respectively formed at two lateral sides of the sprinkler base while two second main bodies are respectively formed at the front side and the rear side of the sprinkler base, so as to form the sprinkler base in a firm-structure frame shape; the first main bodies and the second main bodies are formed in hollow with thin shell, and a plurality of hollow holes are formed thereon, so as to reduce the weight of the sprinkler base and lower the cost of material in the production, thereby achieving the effects of environmental protection and energy saving; and the hollow holes are adapted to reserve space so as to allow a turf to well grow therefrom.

2. The gardening sprinkler of claim 1, wherein the sprinkler base is integrally made of metal.

3. The gardening sprinkler of claim 1, wherein the sprinkler base is manufactured through injection molding production by more than two sets of molds.

4. The gardening sprinkler of claim 1, wherein each of the first main bodies has a connecting portion at corresponding positions, and the connecting portion is adapted to connect to a sprinkler pipe to achieve watering.

5. The gardening sprinkler of claim 1, wherein each of the first main bodies has a connecting portion at corresponding positions, and the connecting portion is adapted to connect to a sprinkler pipe to achieve watering, and the plurality of hollow holes are formed on the connecting portions.

6. The gardening sprinkler of claim 1, wherein the hollow holes are formed in honeycomb shape.

7. The gardening sprinkler of claim 1, wherein the hollow holes are formed in swirling shape.

8. The gardening sprinkler of claim 1, wherein the hollow holes are formed in irregular nest shape.
